(19) United States
(12) Patent Application Publication
(10) Pub. No.: US 2018/0347173 A1
(43) Pub. Date: Dec. 6, 2018

(54) ELASTO-MECHANICAL CHAMBER

(71) Applicant: Alejandro GAJARDO SILVA, Vina del Mar (CL)

(72) Inventor: Alejandro GAJARDO SILVA, Vina del Mar (CL)

(21) Appl. No.: 15/777,624

(22) PCT Filed: Nov. 8, 2016
(86) PCT No.: PCT/CL2016/000071

§ 371 Date: May 18, 2018

(30) Foreign Application Priority Data
Nov. 20, 2015 (CL) 3408-2015

(51) Int. Cl. E04B 1/24; E04B 9/06; F16B 7/04

(52) U.S. Cl. CPC E04B 1/2403; E04B 2/78; F16B 7/04; E04B 9/06

(57) ABSTRACT

The elasto-mechanical chamber is a device for the internal coupling and joining of C-type structural profiles. According to the invention, by securing the open elastic casing of the chamber by means of mechanical pressure, in a firm but not totally rigid manner, the device allows energy to be dissipated to the profile(s) to which it is joined. The elasto-mechanical chamber covers the single elasto-mechanical chamber and the double elasto-mechanical chamber, both of which have a similar design in terms of shape, number of components and action mechanism, and hence the same name. The features of each can be used to create bi-directional connectors and multi-directional connectors that can meet the different connection requirements of different types of structures and physical bodies.

### STATE OF THE ART

Of the inter-structure connection devices that have comparable connectors with the elasto mechanical chambers, there are two main ones: one, is the tension lock of the OCTANORM ephemeral architecture builder system, owned by the German industry of the same name, and the flange bracket set connection of the Blocan System, from the RK ROSE+KRIEGER industry. It is only possible to describe the connection device object of this memory by making reference to the profile that couples, in the same way, it is only possible to describe the two inter structure connectors against which it is compared, by making reference to the profiles that couple and the mechanisms that they add to solve what they join. To facilitate the comparison with the invented, the web addresses and technical catalogs where this information is found are provided.

### THE TENSION LOCKS OF THE OCTANORM CONSTRUCTIVE SYSTEM

The OCTANORM system was originally created with the purpose of offering to the market a builder system of ephemeral architecture, oriented to the creation of spaces and stands in exhibition fairs of products and services.

This is a modular system of mechanical type composed of a set of rigid profiles of special geometry, original at the time of its creation in the 1970s, and a system of non-visible inter-structural mechanical connectors, since they work included within the profiles that unite, called tension locks. Most of these profiles, square or rectangular, perforated inside and grooved on the outside, are made of aluminum and high molecular weight plastics, in sections that do not exceed seven centimeters in diameter or width and, in long metallic or extruded plastic profiles, which are used as beams or pillars in ephemeral constructions. The section of these has an internal perforation, round, square, rectangular or hexagonal longitudinal geometry tubes, through which they conduct energy and communication networks; the open outer shape of these profiles creates C type channels that act as anchoring elements for the expandable side of the tension locks. These bidirectional interlocking devices, allow other profiles to be connected in parallel, in order to increase the section of the pillar or beam, or to fix plates of rigid material or fabrics to the profiles in order to create independent spaces. The tension lock devices of the OCTANORM system have been indicated as the first comparative reference of the elasto mechanical chambers because they present two common characteristics:

First, both are inter-structure coupling devices that act internally in and between what they unite, their presence being not evident;
Second, the mechanical principle of fixing the tension locks has and that of the mechanical elasto chamber is analogous, a bolt inserted through a perforated plate with thread displaces the opposite plate and retracts the penetrating one producing an effect of expansion of both plates in opposite direction; this expansion, which tightens the sides or inner faces of the profile in which they are introduced, fixes the frontal part of the tension lock inside it.

The coupling of the tension lock to a beam or other material in the opposite direction is produced by snap-fitting the rear part of the tension lock in a slot of the profile, rectangular beam, whose section presents the same width of the rear part of the tension lock. The fixing of this beam is produced by the compression of an elastic rod that carries the tension lock in this section and the head of its bolt, which protrudes through a hole made in the rectangular profile.

About the tension locks design:
They are bidirectional connectors made entirely of aluminum or iron.
Only one of its ends has the described expansion clamp, which is fixed inside a longitudinal external C-shaped groove of the pillar profile, whose shapes are quadrangular, hexagonal, or triangular as a corner.

The opposite end of the tension lock, the one that carries the bolt, has a rectangular geometry whose object is to connect other materials when being introduced by pressure inside of symmetrical perforations with itself.
There are several types of tension locks differentiated only by the angle of the clamp.
The tension locks work with the system's own parts, with the sole purpose of connecting the building materials of ephemeral architecture designed by OCTANORM.
The tension locks are not intended to solve structural problems of weight, nor dilatations, vibrations and movements in general that affect the ephemeral constructions, these, are absorbed by the same fragile, mobile structure that uses them.

Complete information on tension locks can be found in the “Octanorm Product Catalog System Components” (AW-887), p. 227 to 230.

www.octanorm.com

### THE BLOCAN FLANGE BRACKET SYSTEM CONNECTION MECHANISM

RK ROSE+KRIEGER/PHOENIX MECANNO is a North American European holding oriented mainly to the construction of industrial process systems with meccano type, modular, metal structures. Its main production lines are production modules in line with robotic and other machinery, work stations, machine support, and so on. For this, they manufacture an extensive range of special profiles extruded in aluminum and steel, modular and inter connectable, called BLOCAN System.

Characteristics of the flange bracket connection mechanism of the BLOCAN System:
This connector device is composed of T-type spring-loaded nuts (Slot Stone with spring), guide bushings, taps, a perforated plate or flange, and Parker bolts.
The bolts take position in one or the other direction intermediated by the perforated plate or flange. The plate or flange perforated is the element that allows joining profiles, in 180° and 90° by means of bolts and nuts that work alternately in both directions.
The ‘slot stones with spring’ solve the problem of vibrations that affect the structure.
The dilatations are resolved through standard known mechanisms such as absorption plates, expansion joints, others.
The flange bracket connection system is incorporated, not visible, inside the joining profiles. Specific information on the flange bracket connection mechanism of the BLOCAN System can be obtained in the PROFILE TECHNOLOGY catalog, pages 48 to 93, and pages 210 to 253.

www.rk-rose-krieger.com

### BRIEF DESCRIPTION OF THE FIGURES

FIG. 1: represents a volumetric drawing of the singular tubular elastic chamber or, singular elasto mechanical connector.

FIG. 2: represents a cut to the axis of the lateral perforation of the singular tubular elastic chamber of FIG. 1.

FIG. 3: represents a volumetric drawing of a structural use C type profile.

FIG. 4: represents a volumetric drawing of two C type structural use profiles faced in a mirror.

FIG. 5: represents a volumetric drawing of the double tubular elastic chamber or, double elasto mechanical connector, for straight parallel bodies.

FIG. 6: represents a cut to the axis of the lateral perforation of the double tubular elastic chamber of FIG. 5.

FIG. 7: represents a perspective volumetric drawing of a compressed double tubular elastic chamber, in order to allow its installation inside and between two type C profiles that couples and joins facing in a mirror.

FIG. 8: represents a cut to the axis of the lateral perforations of a double tubular elastic chamber, installed and mechanically expanded, inside and between two type C profiles of coupling and joining.

FIG. 9: represents a volumetric drawing of a double elasto mechanical connector of bodies in parallel, at an angle equidistant from a center.

FIG. 10: represents a frontal cut diagram of a double elasto mechanical connector of bodies in parallel, at an angle equidistant from a center.

FIG. 11: represents a cut scheme at the perforations of a double elasto mechanical connector of bodies in parallel, at an angle equidistant from an expanded center, joining, in an inclined position, two C type profiles.

FIG. 12: represents a volumetric drawing of a bent and perforated plate whose purpose is to reinforce, ensure the anchorage of the C type profiles coupled by a double mechanical elasto connector of bodies in parallel, at an angle equidistant from a center.

FIG. 13: represents a volumetric drawing of an elasto mechanical connector with short neck and narrow plate.

FIG. 14: represents a cut scheme, to the axis of the perforations, of an elasto mechanical connector of short neck and narrow plate expanded inside a C type profile.

attach from inside a C type profile.

FIG. 15: represents a volumetric drawing of an elasto mechanical connector of short neck and narrow plate with its elastic body compressed, to allow its installation and coupling inside a C type profile.

FIG. 16: represents a volumetric drawing of an elasto mechanical connector with high neck and wide plate.

FIG. 17: represents a frontal cut diagram of an elasto mechanical connector with high neck and wide plate.

FIG. 18: represents a frontal cut diagram of an elasto mechanical connector of wide neck and great thickness.

FIG. 19: represents a perspective volumetric drawing of an elastic connector of two singular elasto mechanical chambers.

FIG. 20: represents a perspective volumetric drawing of the same elastic connector of two singular elasto mechanical chambers of FIG. 19 indicating the deformable capacity of the neck.

FIG. 21: represents a perspective volumetric drawing of an elastic connector of two singular elasto mechanical chambers and two type C profiles whose longitudinal finger grips have been modified in order to decrease the possibility of cutting the neck.

FIG. 22: represents a front section drawing of an elastic connector of four singular elasto mechanical chambers connected through a solid elastic core.

FIG. 23: this drawing represents an isolated structural type SIP panel, (Structural Insulated Panel) by its acronym in English, whose traditional system of fixation—by means of strips made of wooden plate or wooden beams—has been modified, including in its interior perimeter a C type profile.

FIG. 24: represents a frontal cut diagram of an isolated structural type SIP panel.

FIG. 25: is a schematic drawing of two SIP panels that indicate working positions of two types of elasto mechanical connectors: the high-plate and wide-plate elasto mechanical connector, and the short-necked and narrow-plate elasto mechanical connector.

FIG. 26: is a schematic drawing of two SIP panels that indicate work positions of double elasto mechanical connectors of straight bodies in parallel.

FIG. 27: is a schematic drawing of SIP panels, applied as a perimeter wall indicating the working position on the shoulder of a mechanical elasto connector with high neck and wide plate and, like inclined panels of ceiling/ceiling showing the working position of a connector double mechanical elasto of bodies in parallel, at an angle equidistant from a center.

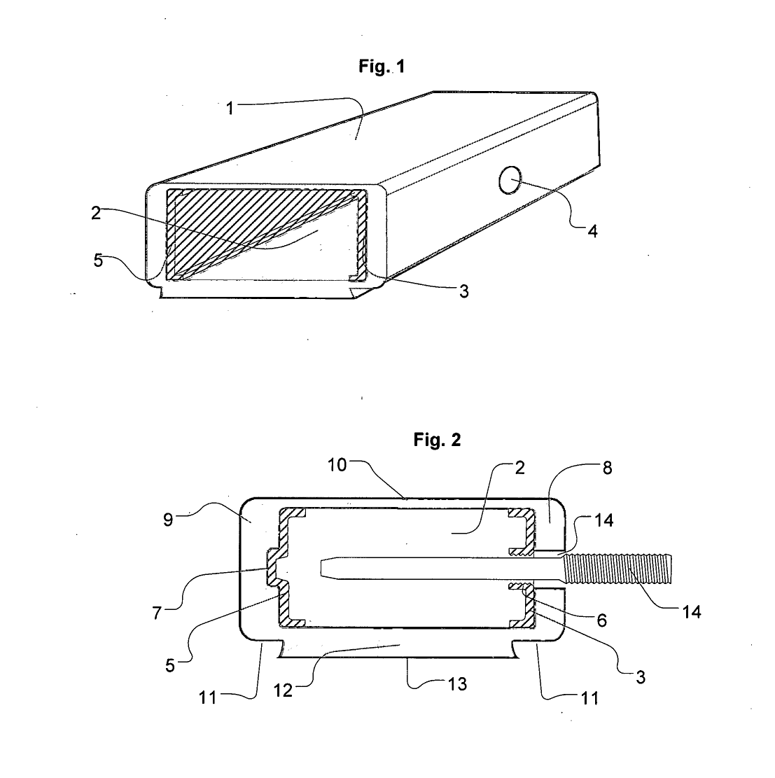

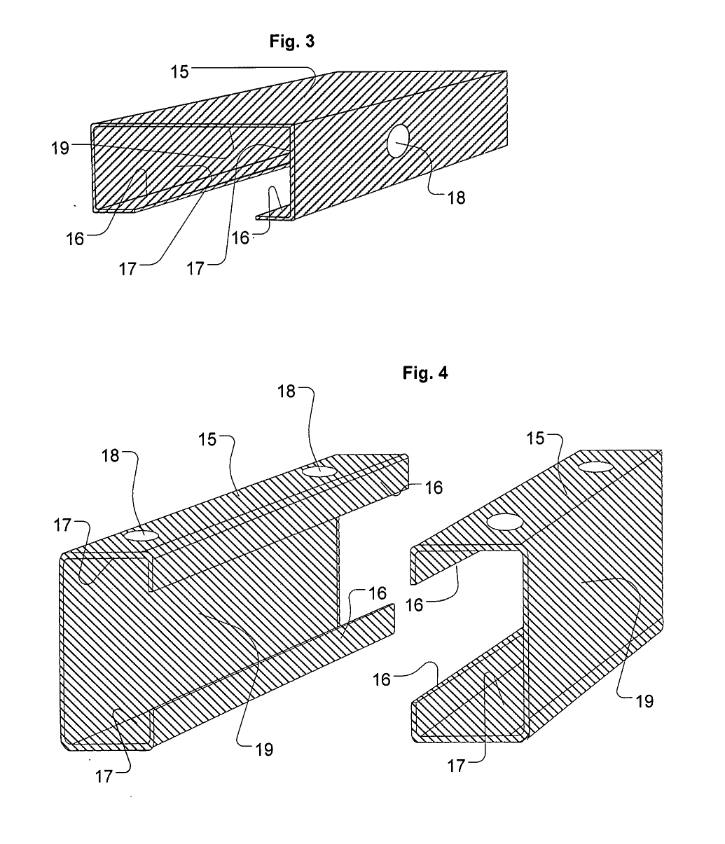

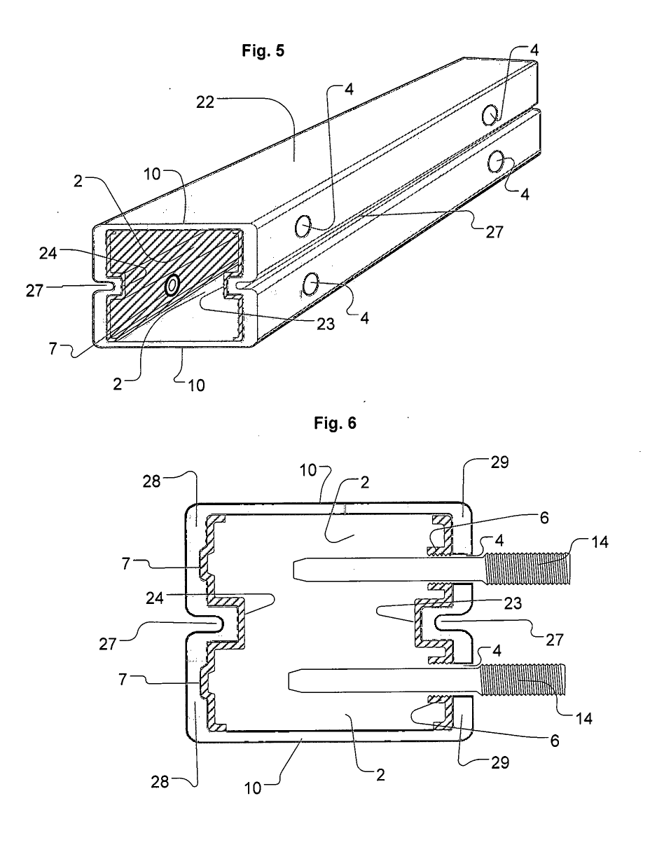

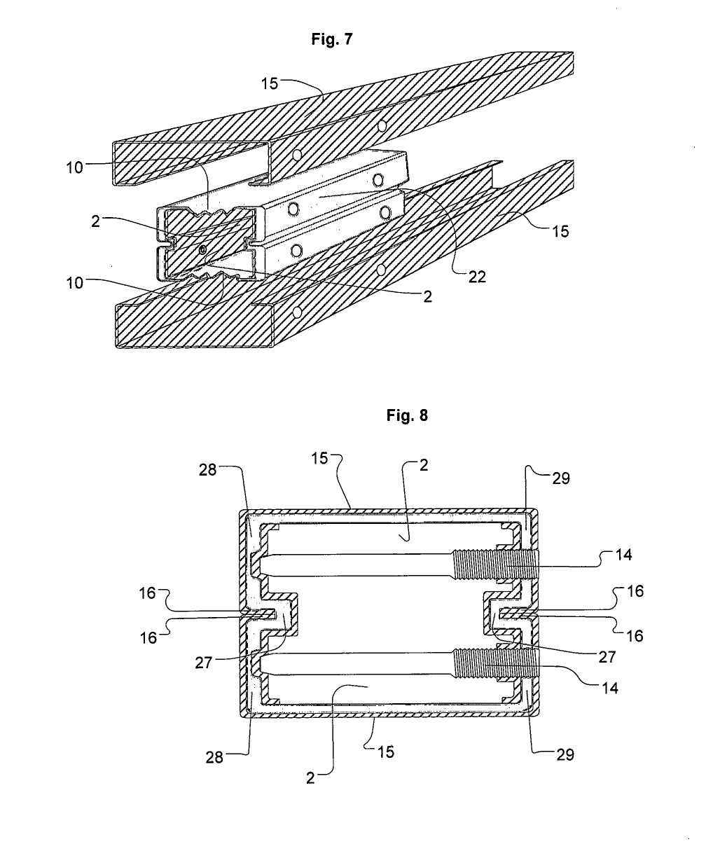

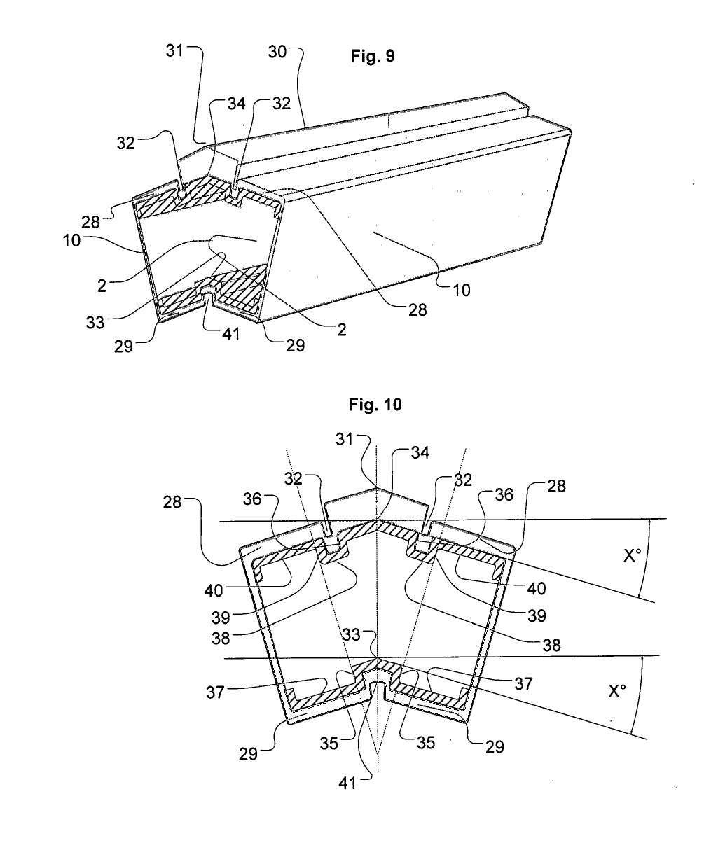

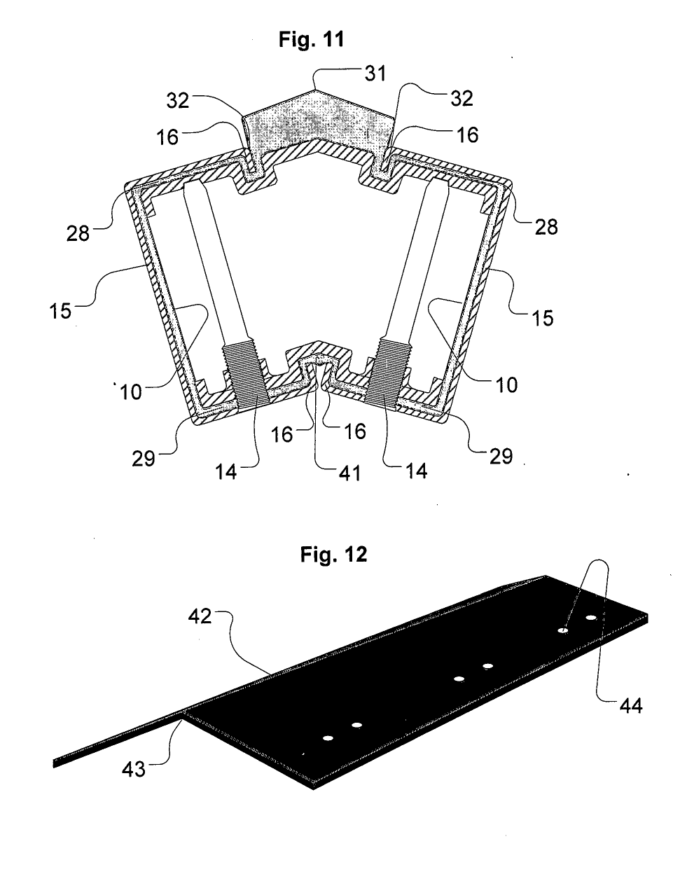

### DETAILED DESCRIPTION OF THE INVENTION

The elasto mechanical chamber is a device for coupling and joining structural C type profiles (15) by the inside, which when fixing its elastic tubular body by mechanical pressure, tenaciously but not completely solid, dissipates energy to the profile it couples or, to the profiles that couples and joins. The elasto mechanical chamber includes the singular elasto mechanical chamber (1) and, the double elasto mechanical chamber (22) both have analogous design of form, mechanism of action, and equal number of components.

The singular elasto mechanical chamber (1) has an elastic, enveloping, tubular, rectangular body of elastomeric material, configured according to a straight or curved linear geometry pattern, that establishes shape and dimensions correspondence with the geometry of the C type profile (15) that couples, its center (2) is an empty longitudinal space, open on both sides. The elastic, enveloping, tubular, rectangular body is formed by two longitudinal parallel faces (8) and (9) of equal thickness, height and length; the faces that form the width of the elastic body are a thin membrane (10) and the opposite face (11), this face is interrupted by the elastic neck (12) that ends in a smooth surface (13) or contact face. The side or face (8) has one or more perforations (4) centered with respect to the height of the rectangle formed by the elastic body without the elastic neck (12) and the inner height (17) of the C type profile (15). Inside of it, face (8) houses a pressure plate (3) that carries one or more threaded perforations (6) aligned with the perforation/s (4), with which forms a single (4-6) perforation, the material of plate (3) must be rigid or semi-rigid, strong enough to resist the working pressure to which is submitted.

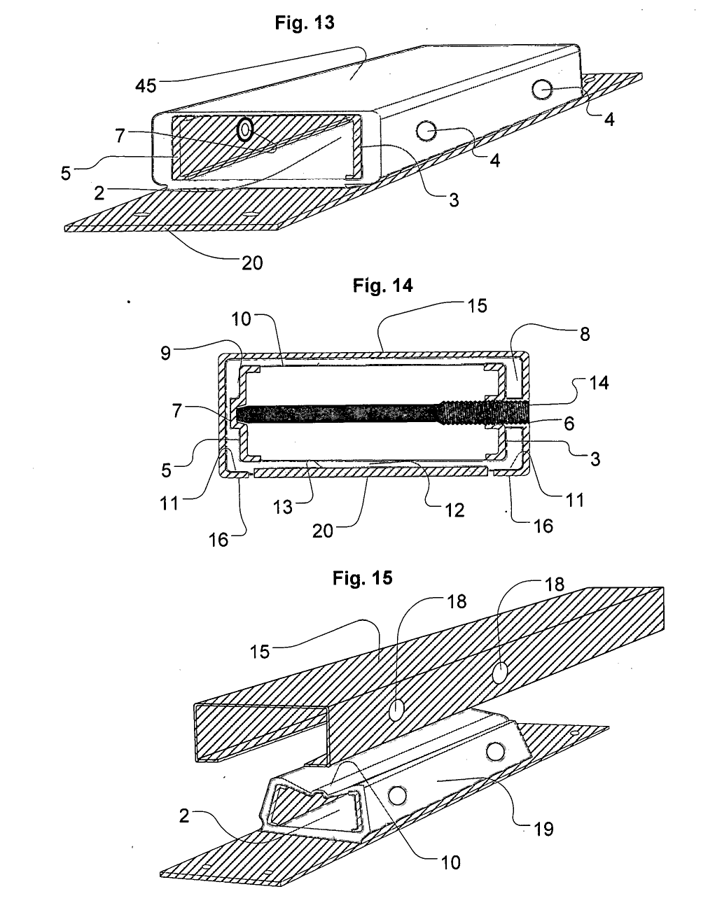

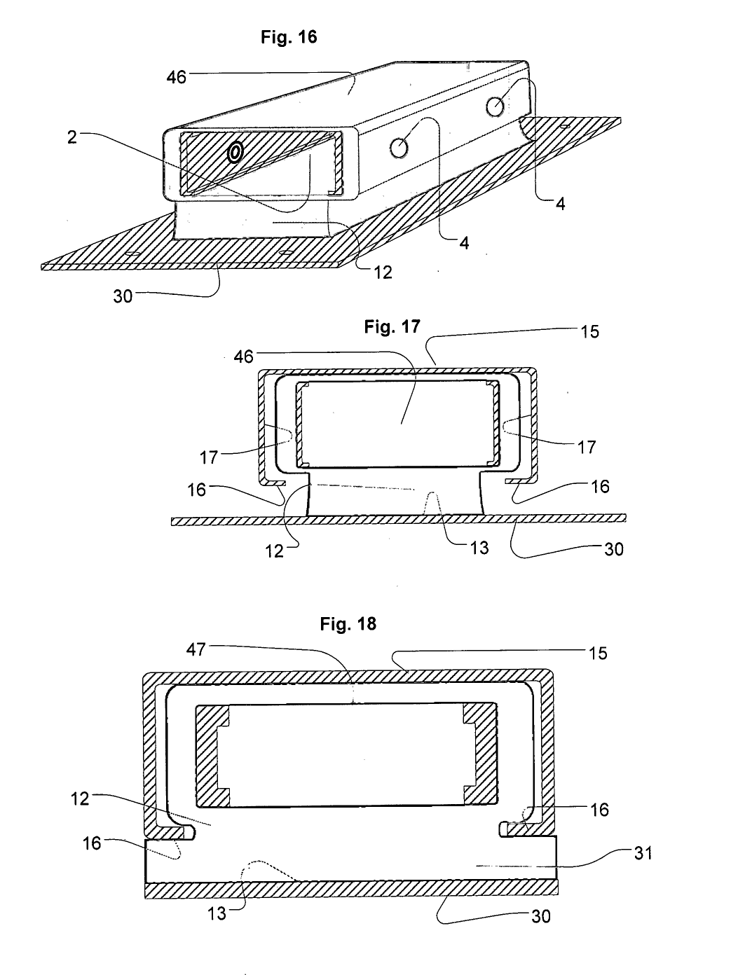

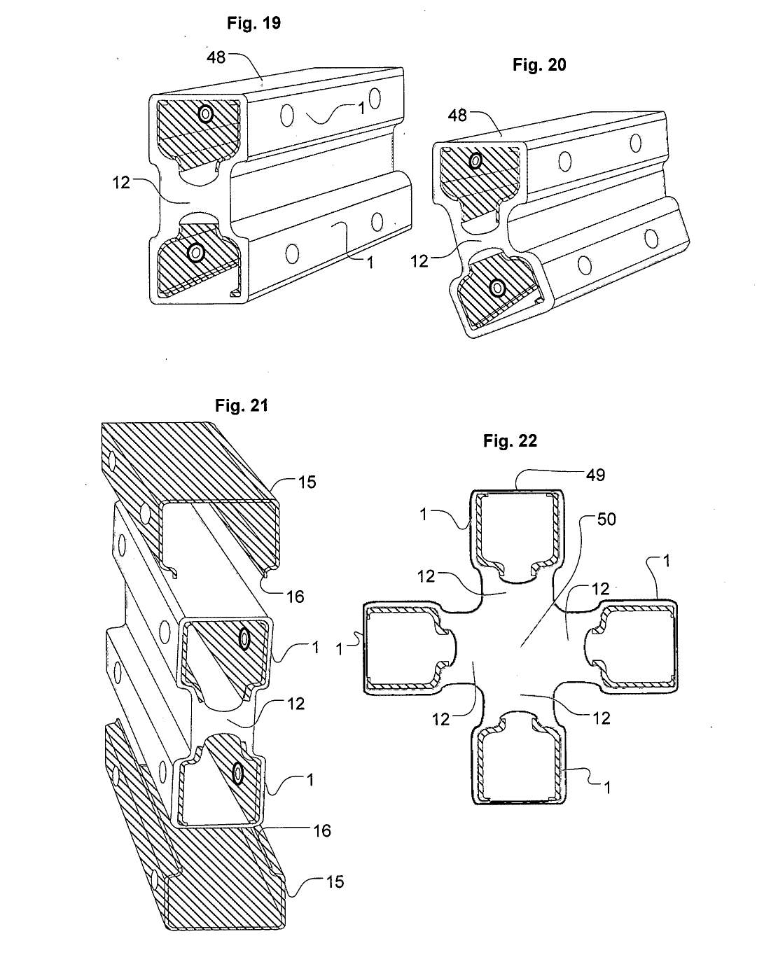

The side or face (9) is a flat plane that houses inside it a pressure plate (5) that carries one or several blind conical grooves (7) which are geometrically aligned with the threaded perforation/s (6) of plate (3), the material of plate (5) must he rigid or semi-rigid, strong enough to resist the pressure to which it is subjected in work. The pressure plates (3) and (5) can present variants to their design: they can be straight or curved planes, have folds on their longitudinal sides or, lateral inclination towards one side according to angles determined by the need of orientation towards one or another side of the elastic mass that they displace by compression; can incorporate in their design bushings in order to increase the resistance of the threaded perforation (6) in the plate (3) or, to ensure the centering of the bolt (14) on the blind conical groove (7) of the plate (5). The thin membrane (10) of the elastic body is intended to allow deformation by manual pressure towards the center of sides (8) and (9), of the singular elasto mechanical chamber (1), in order to introduce this one inside the C type profile that couples, the working position of the membrane (10) is stuck against the surface (19) of the profile interior width. The lower face of the elastic body (11) is interrupted by the elastic neck (12) that ends in a smooth surface (13) or contact surface. The elastic neck (12) can undergo multiple transformations, and join to one other or others singular elasto mechanical chambers (1). Through the contact surface (13), various plates or artifacts can be joined by adhesives or mechanical means. The feasible modifications that can be made to the elastic neck (12) and, the incorporations of various elements through the contact surface (13), allow to configure an important series of bidirectional and/or multidirectional elasto mechanical connectors, which are graphically shown between FIGS. 13 to 22, which will be described in more detail when analyzing these.

The structural use C type profile (15) has a shape of rectangular or square geometry with one side of the width partially cut, two longitudinal fingers grips (16) and (16) of equal magnitude, determine the typical figure of the C type profile. These fingers grips (16) and (16) are placed in parallel with the face (19) and make a right angle with the parallel faces (17) and (17), flat and equal sides, that make up the height of the C profile. This profile can present a rectangular or square shape, or semi-rectangular or semi-square, of straight linear geometry or curve, all its dimensions can vary in thickness, width, height and length. It can be manufactured with a material of different thicknesses but rigid and resistant enough to contain the mechanical pressure exerted by the expanded elasto mechanical chamber (1), with no substantial alteration of its original folded, extracted, molded or stamped form. The C-type profile must have centered perforations (18) on its height to allow the chamber couple inside of it.

Both the singular mechanical elasto chamber (1) and the double mechanical elasto chamber (22) are mechanically activated by a modified bolt (14), the changes made in the design of this bolt (14) arc the following: two thirds of the length of the body is a straight solid cylinder without thread whose diameter is smaller than the diameter of the thread that makes up the third part of it; the anterior part of the solid cylinder without thread ends in a truncated conical shape whose section corresponds in its measurements with the blind conical groove (7) and (7/7) of the pressure plates (5) and (24) of the chambers (1) and (22); the bolt (14) can have any type of head, hexagonal, square, cylindrical grooved, or other heads inserted in the cylinder, by means of a perforation or partial slit, of various types of Phillips, pentagonal or hexagonal, such as the head described in the drawings of the bolt commonly known as prisoner Allen. The materials with which these bolts (14) can be manufactured are multiple, must be strong enough for the thread to withstand the pressure and vibrations that can affect the elasto mechanical chamber in which it is included. The modifications made to the design of the bolt have the following sense: when the bolt (14) is screwed into the perforation with thread (4-6) of the side (8) and the plate (3) and its front end is centered by the conical groove (7) of plate (5) and side (9), of the singular mechanical elasto chamber (1), exerts simultaneous pressure on both plates and sides, retracts the plate (3) and pushes the plate (5), expanding with the same magnitude of force the sides (8) and (9) against the side walls (17) and (17) of the C type profile and against the segments (11 and 11), of the lower face of the elastic body, which rest upon the longitudinal finger grips (16 and 16) of the profile (15), consequently, the pressure exerted by the modified pin (14) allows the singular mechanical elasto chamber device (1) to be fixed by elastic mass pressure of its enclosing body against the internal faces of the profile, in a tenacious but not totally solid way. The double elasto mechanical chamber device (22), is also called double elasto mechanical connector of parallel, straight bodies. The central empty space (2/2) allows the fitting of this connector, by manual compression, inside and in between the C type profiles (15) and (15) and couple and join them together in a mirror.

The double elasto mechanical chamber (22) has an elastic, enveloping, tubular, rectangular or square body of elastomeric material, configured according to a straight or curved linear geometry pattern that corresponds with the geometry of two C type profiles that couples and unites. Its center (2/2) is an empty, longitudinal space, opened on both sides. The width of this elastic, enveloping, tubular, rectangular body is formed by two parallel longitudinal membranes (10) and (10) of equal thickness, its lateral faces (29-27-29) and (28-27-28) each is formed by two flat segments (29) and (28) of equal thickness, height and length and, between these segments, separating them, runs a U-shaped groove or channel (27), whose dimensions and characteristics are identical to each other. In practical terms, the double U-shaped grooves (27) and (27) link, unite, and relates in terms of work, two singular elasto mechanical chambers (1) and (1) without neck (12). The double slots (27 and 27) allow the fitting of the pair of longitudinal finger grips (16) and (16) and, (16) and (16) of two C type profiles, facing each other in a mirror, and join one with the other by elastic mass pressure, whereby this coupling and joining device incorporates between the bodies that joins an energy dissipating element.

The sides (29-27-29) and (28-27-28) of the double mechanical elasto chamber (22) adhere in their interior two plates (23) and (24) whose shape has a central longitudinal channel in U, which has been designated with the same nomenclature (23) and (24) of each plate, these are located centered with respect to their respective lateral planes with which, together, they give shape to the pressure and double union plates (23) and (24). The pressure and double joint plate (23) has two or more pairs of perforations with parallel (6/6) thread, these are geometrically aligned and centered with respect to its lateral ends and the center of the U-channel (23); the pressure and double union plate (24) has two or more pairs of blind conical grooves (7/7) geometrically aligned with respect to the threaded perforations (6/6), and both centered to its lateral ends and the center of the U-channel (24).

The double elasto mechanical connector of parallel, straight bodies (22) positioned in between two C type profiles, each has one or more perforations (18) and (18) on one of its sides (17) centered with respect to its height, when the bolts (14 and 14) penetrate the double perforations with thread (4-6/4-6) of the side (29-27-29) and plate (23), and press the double conical grooves (7/7) of the side (28-27-28), of the pressure plate (24), simultaneously expand both plates in opposite directions and press the elastic mass against the side walls (17 and 17) and against the longitudinal fingers grips (16 and 16) and (16 and 16) of the two C type profiles, achieving, by means of elastic mass pressure to join the C type profiles together, facing each other in a mirror, in a tenacious but not totally solid way. The pressure plates (23) and (24) can present variants to their design: their lateral sides can be straight planes, curved, or present preferential inclination towards the center, according to angles determined by the need of orientation of the elastic mass that is moved by compression towards the central channels (27); these plates can incorporate in their design bushings in order to increase the strength of the thread in the double perforations (6/6) of the plate (23) or, to improve or ensure the centering of the bolts (14 and 14) on the blind conical grooves (7/7) of plate (24).

The double elasto mechanical connector of parallel, straight bodies (22) can, through design modifications to its inner plates and to the tubular elastic body, transform into a double elasto mechanical connector of bodies in parallel, at an angle equidistant from a center, the operational characteristics of these connectors are completely analogous. The design elements that differentiate the double elasto mechanical connector from bodies in parallel, at an angle equidistant from a center (30) with respect to the double mechanical elasto connector of parallel, straight bodies (22), establishes differences in each of the plates that adheres inside and, substantively modifies the face (28-31-28) of the double elastic body.

The double elasto mechanical connector of bodies in parallel, at an angle equidistant from a center (30) contains a pressure plate (33), of the same denomination as its center, which originates a central pentagonal figure with four inclined faces and an imaginary basal line, the bent produced at point (33) is a variable obtuse angle, from which two inclined planes of equal dimensions running along the length of the connector are projected, the sides (35) and (35) of the pentagonal form, make a straight angle with the central inclined planes and, other straight angle with the lateral planes (37) and (37).

Opposite to the pressure plate (33) the connector (30) contains another pressure plate (34), of the same name as its center, this plate forms a pentagonal figure with center at (34) with four inclined faces and one basal imaginary line, the bent that occurs in point (34) forms a variable obtuse angle, from it, two inclined planes of equal dimensions that run along the entire length of the connector are projected; the sides (36 and 36) of the pentagon form a right angle with the central inclined planes and, forming one of the parallel sides of a double U channel (38) and (38) that is created on each side of the pentagonal shape, the sides (39 and 39) of the U channels (38 and 38) are located in a straight line with the side (35 and 35) of the pentagonal central channel created by plate (33); the inclined planes (40) and (40) snake a straight angle with the sides (39) and (39) of each side of the U channels (38 and 38), and, they are parallel straight planes, of equal dimension in width and long, with the inclined planes (37 and 37) of the plate (33). The lateral planes (37 and 37) of the pressure plate (33) can carry, indistinctly, one or more double parallel perforations with thread (6/6) or, one or more double blind conical grooves (7/7); the lateral planes (40 and 40) of the pressure plate (34) can carry, indistinctly, one or more double parallel perforations with thread (6/6) or, one or more double blind conical slits in parallel (7/7). The dimensions of the two rectangles formed by the double elasto mechanical connector of bodies in parallel, at an angle equidistant from a center (30), configured by the external segments (28/10/29) and (28/10/29) of the tubular elastic body and with the corresponding segments of the pressure plates (34) and (33), correspond symmetrically with two C type profiles that join together.

The tubular elastic body that forms the external body of the double elasto mechanical connector of bodies in parallel, at an angle equidistant from a center (30), produces an isosceles triangle with an obtuse angle at its bottom, its apex being a U-channel (41) elastic, deformed, composed of the legs (29 and 29) of equal dimensions, its base is an imaginary line that joins the ends of these legs; in its upper part, this tubular elastic body, forms a pentagonal shape with center in. (31) four inclined planes and an imaginary basal line, the point (31), which is determined in the same line joining the points (33) and (34) of the pressure plates, is the center of a variable obtuse angle of equal dimension that the angles with center in (33 and 34), from it projects two central inclined planes of equal dimensions that run throughout the length of the connector, the sides (32 and 32) of the elastomeric pentagon form a right angle with the central inclined planes and another right angle also with the lateral planes (28 and 28); the number given to the sides (32 and 32) of the pentagon also refers to two elastic channels whose shape is a U, which settle or takes shape inside the U channels (38) and (38) of the pressure plate (34); the height of the sides (32) and (32) of the pentagonal elastomeric shape should be equal to the height of the longitudinal finger grips (16) of the C-type profile (15) plus the thickness of the material that can be attached or joined by the high to the profile type C (15); each of the sides of this tubular elastic body is formed by a membrane (10) and (10), which can be manually compressed for the purpose of installing the double mechanical elasto connector of bodies in parallel, at an angle equidistant from a center (30) inside of two type C profiles.

The coupling and joining mechanism produced by the double mechanical elasto connector of bodies in parallel, at an angle equidistant from a center (31), is analogous to the way in which the connection between the C type profiles (15) that couples and connects the double mechanical elasto connector of bodies in parallel, straight (22), described above, there being a difference between them in consideration of the space or distance that produces the angle that determines the dimensions of the central inclined planes of the pentagonal shape with center in (31), consequently, the pressure exerted by deformation of the elastic body on the longitudinal finger grips (16) of the C-type profile (15) that are anchored inside the U-channels (32) and (32) is insufficient and must be reinforced. The reinforcement or securing of the anchorage of the longitudinal finger grips (16) of the C type profile that are fixed inside the U-channels (32) and (32) must be done by means of the inclusion of a bent plate (42) and perforated laterally (44) whose central angle (43) must be equal to the obtuse angle determined at point (31) and, the length of this plate must be equal to that of the connector (30); the position of the perforations (44) of the bent plate (42) must coincide with the center of the height (17) of the C type profile that engages and joins, preventing these perforations (44) from coinciding with the position of the perforations with thread (6/6) or the blind conical grooves (7/7) of the pressure plates and, the amplitude of their sides must be at least twice as great as the distance between the center (31) and the meeting point between the elastic segment (28) and the compressible membrane (10).

### Bi-Directional and Multidirectional Elasto Mechanical Connectors

The singular elasto mechanical chamber (1), independently, is only a mechanical device that can be incorporated into a structural use C type profile (15) but, the modifications practicable to the dimensions and projections of its elastic neck (12), added to the possibility of incorporating multiple planes and mechanical devices through the contact surface (13) and, the feasibility of joining through the same elastic neck two or more independent elasto mechanical chambers, make possible to configure series or families of bi-directional and multidirectional elasto mechanical connectors. The characteristics of three bi-directional elasto mechanical connectors and, of independent elasto mechanical chambers connectors will be described below.

The elasto mechanical connector of short neck and narrow plate (45) works totally included in the C type profile (15) because both, the elasto mechanical chamber (1) and the narrow fixation plate (20) are literally lost inside the C type profile (15). The fact that this connector is totally included in the profile that couples, defines that its total height is determined by the height of the chamber plus the thickness of the plate, which conditions the characteristics of the thickness of the elastic body and the dimensions and position of the pressure plates (3) and (5), because the threaded perforation (6) and the blind conical groove (7) of the plates must be geometrically aligned with the perforation (18), centered with respect to the profile height.

The elasto mechanical connector of high neck and wide plate (46) operating distanced from the type C profile (15) is intended to provide a versatile type of connector that allows to attach bodies at different angles than 180°, the wider and larger dimensions of the broad plate (30) has the purpose of facilitating the fixation of the connector to what joins in an inclined plane, union that can be done by screws, bolts, welding, or adhesive.

The large-thickness, wide-neck elasto mechanical connector (47) has a design where the greater thickness (31) of the elastic neck (12) fulfills a main function as an energy dissipating mass, since, over this, throughout the connector's length the longitudinal fingers grips are supported. Applications for this type of connector are numerous: as structural support of large weights and volumes in all types of construction, of engines, in traffic routes of various vehicles and high traffic pedestrian, others.

The connecting device of independent elasto mechanical chambers (48), is characterized in that it joins two or more singular elasto mechanical chambers (1); through the extension or branching of the elastic neck, it forms a universe of elasto mechanical connectors of great amplitude and variety of types. In these, both the extension, bifurcation or branching of the elastic neck (12) of the singular mechanical elasto chamber (1), and the design of the core (50), which joins or relates the elastic necks in a single point, can adhered to patterns of regular geometry or present asymmetrical plastic forms; in turn, the geometry, measurements and design characteristics between one and another singular mechanical elasto chamber can be identical or totally different from each other, both in the form of the enclosing elastic chamber and the internal plates; the inside of the neck and core, or one or the other, can be reinforced by various non-elastic elements, have internal perforations, incorporate tubes, cables or other elements of diverse nature.

The design of the C type profile (15) can present a rectangular or square configuration of straight or curved linear geometry, the longitudinal finger grips (16) can be designed adaptively to the uses and functions of the connector; the materials with which these profiles can be constructed can be of different mineral or chemical origin, and variable plasticity, having only to meet the requirement of rigidity, resistance to deformation, product of the internal pressure caused by the connector expansion in its fixation.

### Description of a Potential Application

The elasto mechanical connectors can be used as quick coupling devices with which it is feasible to build a house in the manner of a meccano. In view of the fact that the connectors work inside a C type profile, the material chosen to achieve the stated purpose are the isolated structural panels (51) type SIP—Structural Insulated Panels—for their acronym in English. The SIP panel is a composite construction material, which integrates two plywood panels (52) and (52) laminated plywood or OSB—Oriented Strand Board—of 4′×8′ feet or 1,220×2,440 millimeters, with a center of insulating material (53), normally made of expanded polystyrene of 24 kg/m3 (insulation that is attached to the boards by means of adhesive) or, in polyurethane foam (self-adhesive material).

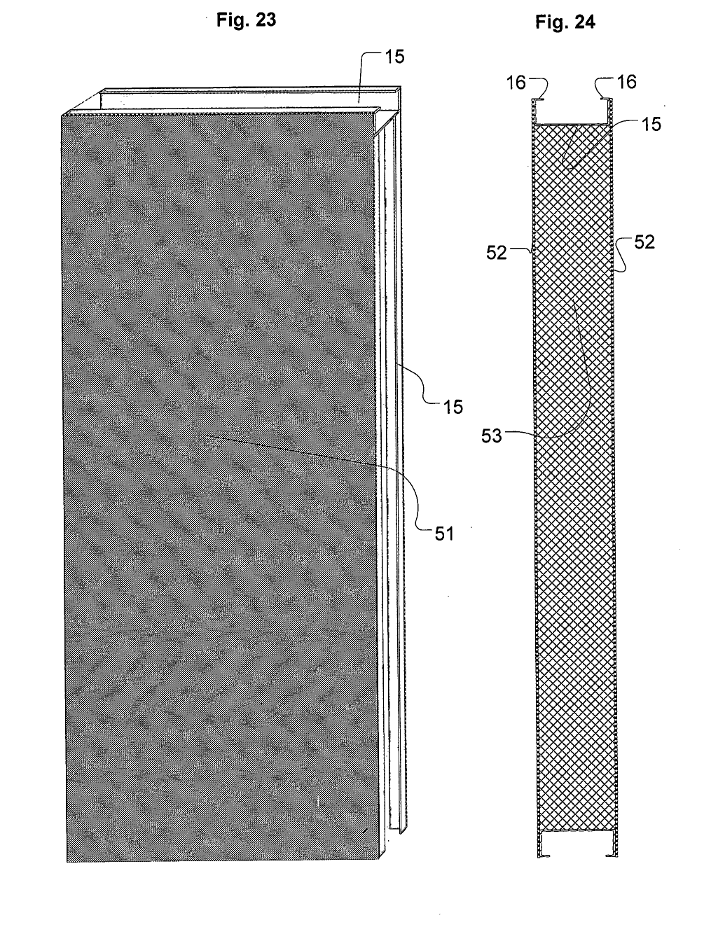

The modification required for its adaptation as a fiat component: of a meccano type construction system, consists in excavating the insulating material around the perimeter of the panel and incorporate in it a C type profile (15) for structural use, arranged with the C form C outward, or with the longitudinal fingers grips (16/16) against the edges, as shown in FIGS. 23 and 24.

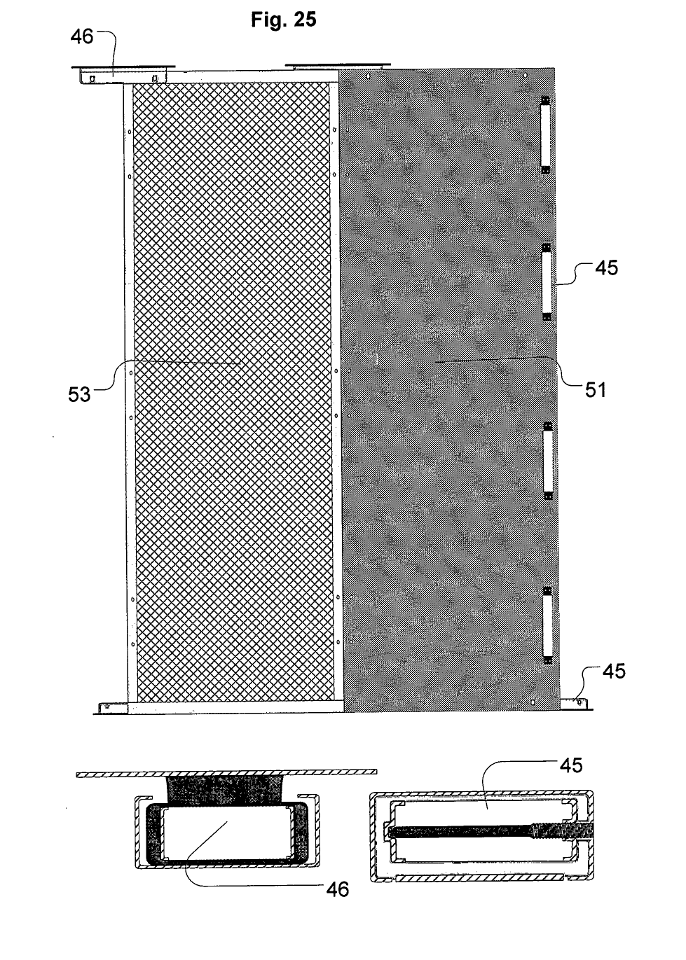

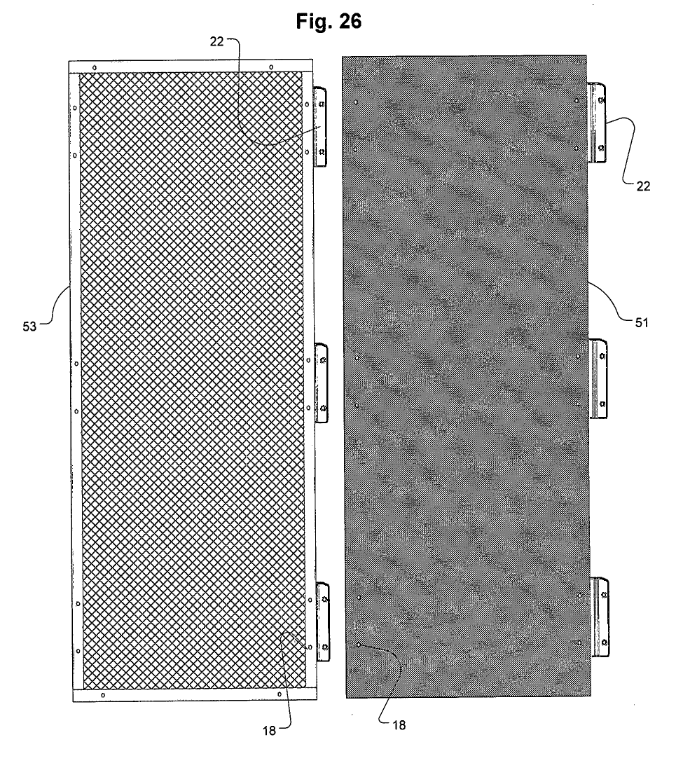

FIG. 25 shows two SIP panels, to the left of the drawing there is a panel (53) without hoard covers (52) that indicates how the C type profile is installed around its perimeter and, the one on the left shows a covered SIP panel (51). The panels are installed against the floor or flooring surface by short-neck and narrow-plate elasto mechanical connectors (45), these connectors are shown schematically protruding at the lower lateral ends of FIG. 25, These same connectors (45) are used in vertical position for the effect of producing corners at a right angle. On the upper edge or, on the shoulder of the panel, two elasto mechanical connectors with high neck and wide plate (46) are shown, with the one on the left superimposed on the C-type profile and the next one protruding at the junction between the two panels, included in the profile. FIG. 26 shows the same two panels (53) and (51) of the previous figure, this time pointing to double elasto mechanical connectors for straight parallel bodies (22). These same connectors (22) can be used to produce the union in floor construction with modified SIP panels,

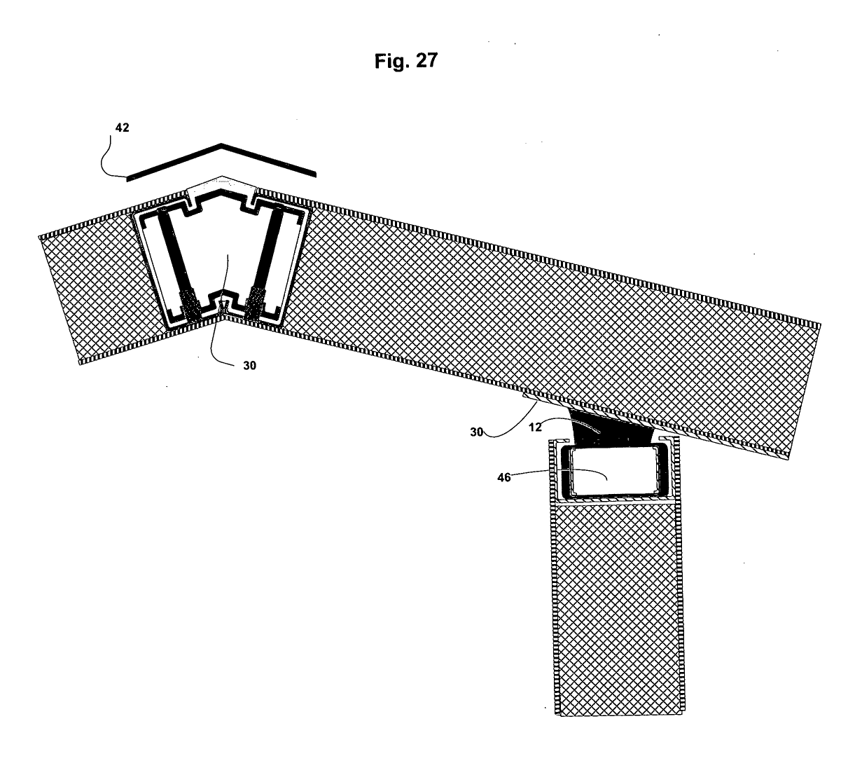

FIG. 27 is a schematic section of two inclined SIP panels and a vertical panel. With the inclined panels, the roof and ceiling surfaces of a house are built, these are joined at the ridge through a double elasto mechanical connector of bodies in parallel, at an angle equidistant from a center (30) and, on top of it, a bent plate (42) is shown, this plate reinforces the connection on the ridge of the house with the inclined panels. On the shoulder of the vertical panel that forms the wall, there is an elasto mechanical connector with high neck and wide plate (46) with the elastic neck (12) stretched on one side, joining the wall panel with the sky/ceiling panel.

1. Device for coupling and joining of structural use type C profiles that allows to dissipate energy in the coupling elements, whose common denominator is elasto mechanical chamber, CHARACTERIZED because:
It comprises two elasto mechanical chambers (1) and (22) whose mechanism of action is analogous, these are configured by an enveloping, tubular, rectangular elastic body that has an empty open, longitudinal, central space (2) and (2/2); the characteristics of the singular elasto mechanical chamber (1) and those of the double elasto mechanical chamber (22), coherently, of the characteristics of the set of pressure plates (3) and (5), and (23) and (24), that integrates each one in its interior, they establish unique functions and create different potentials for one and another camera.

2. Device according to claim 1, characterized in that:
the elastic, tubular, rectangular, elastic body of the singular and double elasto mechanical chambers (1) and (22) is made of elastomeric material, configured according to a linear straight or curve geometry pattern, that establishes correspondence of form and measurements with the geometry of the type C profile that couples and, whose center (2) and (2/2), respectively, is an empty opened space on both sides.

3. Device according to claim 1, characterized in that:
the singular elasto mechanical chamber (1) has a center (2) which is an empty, longitudinal space opened on both sides, delimited laterally by the pressure plates (3) and (5), by the compressible membrane (10), and by the side (11) which is interrupted by the elastic neck (12), the space (2) can be manually deformed or folded inwardly under the membrane (10) in order to allow the installation of the singular elasto mechanical chamber (1) inside the type C profile (15) that couples; and, because the double elasto mechanical chamber (22) has an empty center (2/2) that is a longitudinal space, open on both sides delimited by the compressible membranes (10) and (10) and by the lateral pressure plates (23) and (24), which can be compressed, joined towards the center, by virtue of the deformation capacity of the membranes (10/10), in order to allow the installation of the double elasto mechanical chamber (22) inside and between the C type profiles (15) and (15) that couples and joins together, in the same action, facing each other in a mirror.

4. Device according to claims 1 and 2, CHARACTERIZED because:
the side (8) of the singular elasto mechanical chamber (1) has a perforation (4), centered with respect to the height of the side (8) and of the height of the C type profile that couples, coinciding with the threaded perforation (6) of plate (3), consequently forming a single perforation (4-6) that houses a pin (14) whose previous segment has been modified according to the function it fulfills.

5. Device according to claims 1 and 2, CHARACTERIZED because:
the side (29-27-29) of the double elasto mechanical chamber (22) has one or more double parallel perforations (4/4) coinciding with the double threaded perforation (6/6) of plate (23), both perforations are centered with respect to the height of the type C profiles (15 and 15) that couple and join, forming on this side a double perforation (4-6/4-6) that houses two bolts (14) and (14).

6. Device according to claims 1 and 2, CHARACTERIZED because:
the side (9) of the singular elasto mechanical chamber (1) contains on its internal face a plate (5) characterized in that it carries one or more blind conical grooves (7) centered with respect to the height of the side (9) and of the height of the profile type C (15), groove that is geometrically aligned with the perforation with thread (4-6) on the opposite side;
the pressure plates (3 and 5) can present variants to their design: they can be straight or curved planes, have folds on their longitudinal sides or, lateral inclination preferred towards one side, according to angles determined by the need of orientation towards one or another side of the elastic mass that they displace by compression; can incorporate in their design bushings in order to increase the resistance of the perforation thread (6) in the plate (3) or, ensure the centering of the bolt (14) that produces the blind conical groove (7) of the plate (5).

7. Device according to claims 1 and 2, CHARACTERIZED because:
the side (28-27-28) of the double mechanical elasto chamber (22) contains on its internal face a plate (24) characterized in that it has one or more double blind conical grooves (7/7) in parallel, each indentation is centered with respect of the height, of one side of the related singular elasto mechanical chambers, that form the elastic double tubular body and, of the height of the C type profile that each one engages and, both, geometrically aligned with the double threaded perforations(4-6/4-6) on the opposite side.

8. Device according to claims 1 and 2, CHARACTERIZED because:
the singular mechanical elasto chamber (1) and the double mechanical elasto chamber (22), both establish shape and size correspondence with the internal rectangular geometry of the C type profile (15) that couple and, the two profiles that couple and unite arranged in a mirror.

9. Device according to claims 1 and 8, CHARACTERIZED because:
the structural use C type profile is a rectangular or square geometric shape of equal parallel sides, where one of the sides of the width is cut along its entire length, forming two blocks (16) and (16) of equal magnitude that make up the C form in all its extension, these finger grips run parallel with the opposite face (19) and, in angle with two flat, equal and parallel faces (17) and (17), that make up the height of the profile; the C-type profile can have a rectangular or square shape, or semi-rectangular or semi-square, of straight linear or curved geometry, of variable dimensions in width and height; can be manufactured with different thickness; the material that forms it is also variable, but has to be rigid and resistant enough so to contain the mechanical pressure exerted by the single elasto mechanical chamber (1) and the double mechanical elasto chamber (22) expanded, without substantially altering its original extruded, molded or stamped shape, and; the profile must have one or more perforations (18) centered with respect to the height of one of its lateral faces (17), so that these chambers can be fixed inside of it.

10. Device according to claim 9, CHARACTERIZED because: the external form C of the profile (15) comprises, in its interior, two C forms faced in mirror, joined through a common flat surface (19), each of which is configured by the longitudinal tab (16), the face (17) of the height, and a part of the common flat surface (19) of equal width as the longitudinal tab (16).

11. Device according to claims 1 and 8, CHARACTERIZED because:
once the singular elasto mechanical chamber (1) and the double mechanical elasto chamber (22) are installed inside the C type profile (15) that couples the first one, and that connects and joins with another profile the second one, through the perforations (18), disposed by the C type profiles, centered on one of its parallel lateral sides, the chambers (1) and (22) are penetrated, through the threaded perforations (4-6), or the double threaded perforations with thread (4/6, 4/6) by modified bolts (14).

12. Device according to claim 11, characterized in that: the modification in the design of the bolt (14) is that two thirds of the length of the body of the bolt is a straight solid cylinder without thread, whose diameter is less than the diameter of the thread that makes up the third part of the total body, the anterior part of this solid cylinder without thread ends in a truncated conical shape whose section corresponds in its measurements with the blind conical groove (7) and (7/7) of the pressure plates (5) and (24) of the chambers (1) and (22) respectively; the modified bolt (14) can have any type of head, hexagonal, square, cylindrical grooved, or other heads inserted in the cylinder itself by perforation or partial slit, of various forms Phillips, pentagonal or, hexagonal as is the head described in the drawings of a bolt commonly known as an Allen prisoner. The materials with which these bolts (14) can be manufactured are multiple it must be solid enough so that the thread can withstand the pressure and vibrations that can affect the elasto mechanical chamber.

13. Device according to claim 1, CHARACTERIZED because:
when the bolt (14) is screwed into the threaded perforation (4-6) of side (8) plate (3) and centered its front end by the conical indent (7) of plate (5) side (9), exerts a simultaneous pressure action on both plates and sides, retracts plate (3) and pushes plate (5), expanding with the same force magnitude these sides against the side walls (17) and (17) and against the lower face (11) of the elastic body, this expansion, that is retained or contained by the longitudinal finger grips (16) and (16) of the profile, fixes the singular elasto mechanical chamber (1) by elastic mass pressure of its body against the internal faces of the profile, in a tenacious but not totally solid manner.

14. Device according to claims 1 and 8, CHARACTERIZED because:
The singular mechanical elasto chamber device (1) can be called singular elasto mechanical connector.

15. Device according to claims 1 and 8, CHARACTERIZED because:
the double elasto mechanical chamber device (22) by virtue of the central space (2/2) it has, is installed inside and in between the C type profiles by simple manual compression, and is fixed inside, and joins one against the other faced in mirror, by elastic mass pressure of the double tubular, expanded elastic body.

16. Device according to claim 15, characterized in that:
the double mechanical elasto chamber device (22) according to its practical use is also called double mechanical elasto connector of parallel, straight bodies.

17. Device according to claim 16, characterized in that:
the double elasto mechanical connector of parallel, straight bodies (22), externally is configured by a tubular, rectangular or square housing made of elastomeric material, configured according to a straight or curved linear geometry pattern that establishes shape and measurements correspondence with the geometry of two C type C profiles that couples and unites, one against the other. Its center (2/2) is an empty longitudinal space, open on both sides. The width of this elastic, tubular, rectangular body is formed by two parallel longitudinal membranes (10) and (10) of equal thickness, its lateral faces (29-27-29) and (28-27-28), each is formed by two flat segments (29 and 29) and (28 and 28) of equal thickness, height and length, in between these segments, separating them, runs a U-shaped groove or channel (27), whose dimensions and characteristics are identical; these grooves (27) and (27), that link, join, relates in working terms, two singular elasto mechanical chambers without neck (12), allow the fitting of the pair of longitudinal finger grips (16 and 16) and (16 and 16) of two C type profiles faced in a mirror.

18. Device according to claim 16, characterized in that:
the double elasto mechanical connector of parallel, straight bodies (22) has two plates adhered therein (23) and (24) its shape has a central longitudinal U shaped channel, which houses the double longitudinal groove (27) and (27) of the tubular, elastic body, the double slot (27) and (27) links, unites each other, relates in terms of work, to two singular mechanical elasto chambers (1 and 1) without neck (12).

19. Device according to claim 16, CHARACTERIZED because: the sides (29-27-29) and (28-27-28) of the double mechanical elasto chamber (22) adhere in its interior two plates (23) and (24), whose shape presents a central, longitudinal channel in U, which has been designated with the same nomenclature (23) and (24) of each plate, these channels are centered with respect to their lateral planes with which, together, they give shape to the pressure double union plates (23) and (24); pressure plate (23) presents two or more pairs of threaded parallel perforations (6/6), each other geometrically aligned and centered with respect to its lateral ends and the center of the U-channel (23); pressure plate (24) has two or more pairs of blind conical indents (7/7) parallel and geometrically aligned with respect to the threaded perforation (6/6) and each, is also centered with respect to its lateral ends and the center of the U-channel.

20. Device according to claims 17 to 19, CHARACTERIZED because:
the double elasto mechanical connector of parallel, straight bodies (22) positioned between two C type C profiles (15) and (15), when penetrated by the bolts (14) and (14) through the double threaded perforations (4-6/4-6), simultaneously expands in opposite directions both plates, consequently, presses the elastic mass against the side walls (17 and 17) and (17 and 17), and against the longitudinal finger grips (16 and 16) and (16 and 16) of the two C type profiles, thus achieving, by means of elastic mass pressure, in the same effect, to fix inside and join the profiles one against the other, in a tenacious but not totally solid way;
the pressure plates (23) and (24) can present variants to their design: their lateral sides can be straight planes, curved, or have a preferential inclination towards the center, according to angles determined by the need of orientation of the elastic mass moved by compression towards the central U channels (27); these plates can incorporate in their design bushings, in order to increase the strength of the thread in the double perforations (6/6) of the plate (23) or, to improve or ensure the centering of the bolts (14 and 14) on the double blind conical indents (7/7) of plate (24).

21. Device according to claims 16 to 20, CHARACTERIZED because:
the double elasto mechanical connector of parallel, straight bodies (22) can, by modifying its inner plates and elastic body, transform into a double elasto mechanical connector of bodies in parallel, at an angle equidistant from a center (30).

22. Device according to claim 21, CHARACTERIZED because: the design elements that differentiate the double mechanical elasto connector from bodies in parallel, at an angle equidistant from a center (30) with respect to the double mechanical elasto connector of bodies in parallel, straight (22), establishes differences in each of the plates that adhere inside, create substantial changes on one of the sides of the double, tubular enveloping elastic body.

23. Device according to claims 21 and 22, CHARACTERIZED because:
the double elasto mechanical connector of bodies in parallel, at an angle equidistant from a center (30) contains a pressure plate (33), of the same name as its center, which originates a central pentagonal figure with four inclined faces and an imaginary line basal, the bend that occurs at point (33) is a variable obtuse angle, from it project two inclined planes of equal dimensions that run along the length of the connector, the sides (35 and 35) of the pentagon form a right angle with the central inclined planes and another right angle also with the lateral planes (37 and 37); contains another pressure plate (34), of the same denomination as its center, which forms a pentagonal figure with center at (34), with four inclined faces and an imaginary basal line, the fold that occurs at point (34) is a variable obtuse angle, from it two inclined planes of equal dimensions running along the length of the connector are projected, the sides (36 and 36) of the pentagon form a right angle with the central inclined planes and, make up one of the Parallel sides of a double channel U (38) and (38) that is created on each side of the pentagonal shape, the side (39 and 39) of the U channels (38 and 38) is situated in a straight line with the side (35 and 35) of the central pentagonal channel forming the plate (33); the inclined planes (40) and (40) make a right angle with the side (39) and (39) of each side of the U channels (38 and 38), and, they are parallel straight planes, of equal dimension in width and length, with the inclined planes (37 and 37) of the plate (33).

24. Device according to claims 21 and 22, CHARACTERIZED because:
the lateral planes (37 and 37) of the pressure plate (33) can indistinctly carry one or more double parallel perforations with thread (6/6) or, one or more double blind conical slits in parallel (7/7) ; and, because the lateral planes (40 and 40) of the pressure plate (34) can indistinctly carry one or more double parallel perforations with thread (6/6) or, one or more double blind conical slits in parallel (7)./7).

25. Device according to claims 21 to 24, CHARACTERIZED because:
the dimensions of the two rectangles formed by the double mechanical elasto connector of bodies in parallel, at an angle equidistant from a center (30), configured by the external segments (28/10/29) and (28/10/29) of the body elastic tubular and with the corresponding segments of the pressure plates (34) and (33), keep symmetric correspondence with two type C profiles (15) to which they join in an inclined position, at an equidistant angle from the same

26. Device according to claim 25, CHARACTERIZED because:
the tubular elastic body that forms the external body of the double mechanical elasto connector of bodies in parallel, at an angle equidistant from a center (30) configures two different faces, one, is an isosceles triangle with an obtuse central angle (29-41-29), in its center it creates a channel in semi-rectangular U (41) deformed, the legs (29 and 29) of equal dimension and, its base, is an imaginary line that joins the ends of these legs;
on its upper face (28-32-31-32-28) the tubular elastic body forms a pentagonal shape with center in (31) four inclined planes and an imaginary basal line; the point (31) that is determined in the same line that joins the points (33) and (34) of the pressure plates, is the center of a variable obtuse angle of equal dimension that the angles with center in (33 and 34)), from it project two central inclined planes of equal dimensions that run along the length of the connector, the sides (32 and 32) of the elastomeric pentagon form a right angle with the central inclined planes and another right angle also with the lateral planes (28 and 28);
the number given to the sides (32 and 32) of the pentagon also refer to two elastic channels whose shape is a U, which settle or are configured inside the channels U (38) and (38) created by the pressure plate (3. 4);
the height of the sides (32) and (32) of the pentagonal elastomeric shape must be equal to the height of the longitudinal flange (16) of the C-type profile (15) plus the thickness of the material that can be attached or joined by mechanical means or chemicals, laterally to the type C profile (15);
each of the sides of this tubular elastic body is formed by a membrane (10) and (10), which can be manually compressed for the purpose of installing the double mechanical elasto connector of bodies in parallel, at an angle equidistant from a center (30).), inside of two C type profiles (15) and join them inside each other

27. Device according to claims 25 and 26, CHARACTERIZED because:
the coupling and joining mechanism that produces the double mechanical elasto connector of bodies in parallel, at an angle equidistant from a center (30), is analogous to the way in which the connection between the type C profiles (15) engages and joins the double mechanical elasto connector of parallel, straight bodies (22) described in claim 21, there being a difference between them in consideration of the space or spacing produced by the four planes of the elastic face (28-32-31-32-28); the spacing that occurs between the channels (32) and (32) in which the longitudinal fingers (16) of the C-type profile (15) are anchored determines that the pressure of the elastic mass against the longitudinal fingers anchored inside the channels (32) is insufficient, so it must be reinforced with a complementary element.

28. Device according to claim 27, CHARACTERIZED because:
the reinforcement or securing of the anchor of the longitudinal fingers (16) of the profile type C (15) that are fixed inside the U-channels (32) and (32) in a double mechanical elasto connector of bodies in parallel, at an angle equidistant from a center (30), it must be done by including a bent plate (42) and laterally perforated plate (44) whose angle (43) must be equal to the obtuse angle determined at point (31) and, the length of this plate equal to that of the double mechanical elasto connector of bodies in parallel, at an angle equidistant from a center (30);
the position of the perforations (44) must coincide with the center of the height (17) of the profile type C (15) that engages and joins, avoiding that these coincide with the position of the perforations with thread (6/6) or the slits blind conical (7/7) located in segments (40 and 40) of the pressure plate (28-32-31-3240) and, the amplitude of its sides, must be at least twice as large as the distance between the center (31) and the point of contact between the segment (28) and the compressible membrane (10)

29. Device according to claims 1 and 14, CHARACTERIZED because:
the enveloping, tubular elastic body of the singular elasto mechanical elasto chamber (1) distinguishes six parts in its form, considering that each of these parts fulfills a specific purpose in the configuration of bi-directional and multidirectional elasto mechanical connectors, these parts are the following: the lateral perforated side (8), the opposite flat side (9), the compressible membrane (10), the basal side (11) which is interrupted by the elastic neck (12) and, the contact surface (13) of the elastic neck.

30. Device according to claim 29, CHARACTERIZED because:
the elastic neck (12) of the singular mechanical elasto chamber (1) can be designed in very different thicknesses, hardness and shapes and, through the contact surface (13) can be attached or linked through chemical or mechanical means to rigid, semi-rigid or malleable materials that configure planes of different characteristics, or other surfaces of variable geometry, with articulated devices, or others.

31. Device according to claims 29 and 30, CHARACTERIZED because:
the incorporation to the singular mechanical elasto chamber (1) of another element, of any nature, through the contact surface (13) changes the name of the chamber to that of bidirectional elasto mechanical connector, applied to such or such function.

32. Device according to claim 31, characterized in that:
as an example of what was said in the previous claim will describe the main differential characteristics of three bi-directional elasto mechanical connectors:
first, the elasto mechanical connector of short neck and narrow plate (45), which operates totally included in the type C profile (15);
the elasto mechanical connector of high neck and wide plate (46), which operates detached, distant from the profile type C (15) and;
the elasto mechanical connector of wide neck and great thickness (47) whose function determines its denomination which is, elasto mechanical connector of great energy dissipating capacity (47) in which the neck is transformed into a longitudinal support of the C type profile.

33. Device according to claim 32, CHARACTERIZED because:
the elasto mechanical elasto connector of short neck and narrow plate (45) is totally included in the profile type C (15) both, the elasto mechanical elasto chamber (1) and the narrow fixing plate (20) are completely included inside de inner space of the C type profile (15); the fact that this connector is totally included in the coupling profile, defines that its total height is determined by the height of the camera plus the thickness of the plate which conditions the characteristics of the thickness of the surrounding elastic body and, the dimensions and position of the pressure plates (3) and (5), because the threaded perforation (6) and the blind conical groove (7) of the plates must be geometrically aligned with the perforation (18) which is centered with respect to the height of the C type profile (15).

34. Device according to claim 32, CHARACTERIZED in that:
the elasto mechanical connector of high neck and wide plate (46) the greater length of the elastic neck (12) has for object to distance the singular elasto mechanical chamber (1) with respect to the C type profile, in order to provide a connector that allows coupling bodies at different angles than 180°;
the greater width and length of the wide plate (30) has the purpose of facilitating the fixation of the connector to what joins in an inclined plane, union that can be done by screws, bolts, welding, or adhesive.

35. Device according to claim 32, CHARACTERIZED because:
the large-thickness wide-neck elasto mechanical connector (47) has a design where the greater thickness (31) of the elastic neck (12) fulfills a main function as an energy dissipating mass because, throughout the extension of the connector the longitudinal finger grips are supported;
the applications for this type of connector are large, as structural support of large weights and volumes in all types of construction, engines, traffic routes, others.

36. Device according to claims 1, 8 and 14, CHARACTERIZED because:
by extending and/or branching the elastic neck (12) of the singular elasto mechanical chamber (1) it is feasible to join two or multiple singular elasto mechanical chambers;
the singular elasto mechanical chamber (1) joined through the extension or branching of its elastic neck creates a type of connector that is called the elastic connector of independent elasto mechanical chambers (48).

37. Device according to claim 36, CHARACTERIZED because:
both, the extension, bifurcation or branching of the elastic neck (12) of the singular elasto mechanical chamber (1), and the design of the neck core (50) can adhered to regular geometry patterns or present asymmetrical plastic forms;
the geometry, dimensions and design characteristics between one and another singular mechanical elasto chamber can be identical or totally different from each other, both in the form of the enclosing elastic chamber and of the internal plates;
the inside of the neck and core, or one or the other, can be reinforced by various non-elastic elements, have internal perforations, incorporate tubes, cables or other elements of different nature, for multiple purposes.

38. Device according to claim 36, CHARACTERIZED because:
the elastic connector device of independent elasto mechanical chambers (48), characterized in that it joins two or multiple singular mechanical elasto chambers (1) through the extension or branching of the elastic neck configures a universe of mechanical elasto connectors of great amplitude and variety;
both, the extension, bifurcation or branching of the elastic neck (12) of the singular elasto mechanical chamber (1), and the design of the core (50), which joins or relates the elastic necks in a single point, can adhered to regular geometry patterns or present asymmetrical plastic forms;
the geometry, dimensions and design characteristics between one and another singular elasto mechanical elasto can be identical or totally different from each other, both in the form of the enclosing elastic chamber and the internal plates; the inside of the neck and core, or one or the other, can be reinforced by various non-elastic elements, have internal perforations, incorporate tubes, cables or other elements of different nature, for multiple purposes.

39. Device according to claims 9 and 10, CHARACTERIZED because:
the design of the C type profile (15) may have a rectangular or square configuration of straight or curved linear geometry;
the longitudinal fingers (16) can be designed adaptively to the uses and functions of the connector;
the materials with which these profiles can be constructed can be of different mineral or chemical origin and their plasticity and variable stiffness, having only to meet the requirement of resistance to deformation, product of the internal pressure that causes the expansion of the connector in its fixation.
